(19) United States
(12) Patent Application Publication
(10) Pub. No.: US 2009/0158597 A1
(43) Pub. Date: Jun. 25, 2009

(54) Medical Tubing Cutter

(75) Inventors: Richard M. Braga, North Easton, MA (US); Brett Haarala, Farmingham, MA (US); Kevin Trainor, Greenville, RI (US); Sean McDermott, Hanson, MA (US)

Correspondence Address: TYCO HEALTHCARE GROUP LP, 15 HAMPSHIRE STREET, MANSFIELD, MA, 02048, US

(73) Assignee: Tyco Healthcare Group LP, Mansfield, MA (US)

(21) Appl. No.: 12/332,530

(22) Filed: Dec. 11, 2008

Related U.S. Application Data
(60) Provisional application No. 61/015,260, filed on Dec. 20, 2007.

(51) Int. Cl. B26D 3/16; B26B 13/00

(52) U.S. Cl. 30/92.5; 30/231

(57) ABSTRACT

An apparatus for cutting medical tubes includes a frame having first and second members. Each of the first and second members has a tube support mount to assist in supporting a medical tube. The first and second members are adapted for relative movement between a first position for facilitating positioning of the medical tube proximal the tube supporting mounts and a second position for capturing the medical tube within the tube supporting mounts. A cutting element is mounted to the frame. The cutting element is moveable through a cutting plane and independent of the relative movement of the first and second members to sever the medical tube captured within the tube support mounts when in the second position of the first and second members. A manual member may be operatively connected to the cutting element and actuable through manual manipulation of a health care professional to move the cutting element.

### CROSS-REFERENCE TO RELATED APPLICATION

This application claims the priority to, and the benefit of U.S. Provisional Application Ser. No. 61/015,260, filed on Dec. 20, 2007, the entire contents of which is incorporated herein by reference.

### BACKGROUND

1. Technical Field

The present disclosure relates generally to a medical apparatus. In particular, the present disclosure relates to a medical apparatus and method for selectively cutting a medical tube to a preselected length.

2. Description of Related Art

Medical or catheter tubes include sterilized thin and flexible tubes for use in a variety of medical applications. These medical tubes are considered, for example, for the withdrawal or introduction of medication, fluids for nutritional support, or blood. Catheter tubes have particular application in hemodialysis procedures where blood is withdrawn from a blood vessel and subsequently returned to the blood vessel. In addition, other medical tubes are adapted for expanding a bodily passage or cavity and/or for conveying diagnostic or other instruments. Medical tubes may be permanently placed under the skin or through the skin (e.g. internal catheter or shunt) or, alternatively, may access a body organ and extend from the skin (e.g. external catheter). Applications in which medical tubes are employed include angiographies, angioplasties, endoscopies and biopsies, blood transfusions, dialysis, nutrition and/or drug delivery.

Medical tubes are manufactured in standard sizes and lengths. In many applications, the length of the medical tube needs to be reduced. Inappropriate tube length may increase the risk of accidental dislodgement and/or severe injury due to movement of the tube portion extending from the body. This may increase the risk for local and systemic infectious complications, including, for example, local site infection, blood stream infections, and other metastatic infections.

In general, medical or catheter tubes are cut with a scissor or like instrument. This method of cutting medical tubes, however, may result in a jagged cut or an angled cut, and may disturb or degrade the integrity of the tube, which may result in further patient injury and/or negatively affect the ability to couple the cut end to a medical device. In addition, the cutting procedure is awkward for the clinician. Therefore, there remains a need for an apparatus and method for precisely and safely cutting medical tubes with minimal disturbance to the structural integrity of the tube.

### SUMMARY

Accordingly, the present disclosure is directed to an apparatus for cutting medical tubes. The apparatus includes a frame having first and second members. Each of the first and second members has a tube support mount to assist in supporting a medical tube. The first and second members are adapted for relative movement between a first position for facilitating positioning of the medical tube proximal the tube supporting mounts and a second position for capturing the medical tube within the tube supporting mounts. A cutting element is mounted to the frame. The cutting element is moveable through a cutting plane and independent of the relative movement of the first and second members to sever the medical tube captured within the tube support mounts when in the second position of the first and second members. A manual member may be operatively connected to the cutting element and actuable through manual manipulation of a healthcare professional to move the cutting element.

The first and second member may include respective tube support jaws which define the tube support mounts. The tube support jaws may be adapted for relative pivotal movement between the open position and the approximated position. A visual indicator may be included for aligning the medical tube relative to the tube support mounts and in defined relation with the cutting plane of the cutting element. The tube support jaws may define a slit extending at least partially therethrough and in alignment with the cutting plane of the cutting element. The slit serves as the visual indicator to permit visualization of the medical tube within the tube support mounts.

A manual member may be operatively connected to the cutting element and moveable to cause movement of the cutting element through the cutting plane to sever the medical tube. The manual member may be a lever pivotally coupled to the frame. Alternatively, the manual member is a knob rotatably mounted to the frame to cause movement of the cutting element.

In another embodiment, the medical apparatus for cutting medical tubes includes a handle and a head operatively associated with the handle and having holding structure configured for supporting a medical tube. The head is adapted for movement upon actuation of the handle between an open position to receive the medical tube and an approximated position to capture the medical tube. A blade is mounted for movement relative to the holding structure to cut the medical tube captured by the holding structure. A manual member is operatively connected to the blade and actuable through manual manipulation by a clinician to move the blade.

### BRIEF DESCRIPTION OF THE DRAWINGS

Embodiments of the presently disclosed medical apparatus are described herein with reference to the drawings wherein:

FIG. 1 is a perspective view of a medical apparatus for cutting medical tubes in accordance with an embodiment of the present disclosure;

FIG. 2 is a side plan view of the medical apparatus of FIG. 1 illustrating the tube support jaws in a first open position;

FIG. 3 is a front plan view of the medical apparatus of FIG. 1;

FIG. 4 is a top plan view of the medical apparatus of FIG. 1;

FIG. 5 is a side plan view similar to the view of FIG. 2 illustrating the tube support jaws in a second approximated position with the cutting blade in an unactuated position;

FIG. 6 is a side plan view similar to the view of FIG. 5 illustrating the cutting blade in an actuated position to cut a medical tube to a predetermined length;

FIG. 7 is a perspective view of a medical apparatus for cutting medical tubes in accordance with an alternate embodiment of the present disclosure;

FIG. 8 is a side plan view of the medical apparatus of FIG. 7;

FIG. 9 is a front plan view of the medical apparatus of FIG. 7;

FIG. 10 is a perspective view of a medical apparatus for cutting medical tubes in accordance with another embodiment of the present disclosure;

FIG. 11 is side plan view of the medical apparatus of FIG. 10;

FIG. 12 is a front plan view of the medical apparatus of FIG. 10;

FIG. 13 is a top plan view of the medical apparatus of FIG. 10;

FIG. 14 is a perspective view of a medical apparatus for cutting medical tubes in accordance with an another embodiment of the present disclosure;

FIG. 15 is side plan view of the medical apparatus of FIG. 14 in the open position;

FIG. 16 is a side plan view of the medical apparatus of FIG. 14 in the closed position;

FIG. 17 is front plan view of the medical apparatus of FIG. 14;

FIG. 18 is top plan view of the medical apparatus of FIG. 14;

FIG. 19 is bottom plan view of the medical apparatus of FIG. 14;

FIG. 20 is a perspective view of a medical apparatus for cutting medical tubes in accordance with another alternate embodiment of the present disclosure;

FIG. 21 is side plan view of the medical apparatus of FIG. 20;

FIG. 22 is a top view of the medical apparatus of FIG. 20;

FIG. 23 is a perspective view of a medical apparatus for cutting medical tubes in accordance with another alternate embodiment of the present disclosure;

FIG. 24 is a side plan view of the medical apparatus of FIG. 22;

FIG. 25 is a front plan view of the medical apparatus of FIG. 22 in a closed position;

FIG. 26 is a front plan view of the medical apparatus of FIG. 22 in a closed position;

FIG. 27 is a perspective view of a medical apparatus for cutting medical tubes in accordance with an alternate embodiment of the present disclosure;

FIG. 28 is a side plan view of the medical apparatus of FIG. 27 in a first open position;

FIG. 29 is a side plan view of the medical apparatus of FIG. 27 in a second closed position;

FIG. 30 is a top plan view of the medical apparatus of FIG. 27; and

FIG. 31 is a front plan view of the medical apparatus of FIG. 27.

### DETAILED DESCRIPTION OF THE EMBODIMENT(S)

Embodiments of the presently disclosed medical apparatus will now be described in detail with reference to the drawings in which like reference numerals designate like elements in each of the several views.

The medical apparatus of the present disclosure provides the operator, e.g., healthcare professional, with an apparatus for clearly and precisely cutting medical tubes at a preselected length and leaving a clean straight or linear cut. Moreover, the medical apparatus of the present disclosure provides for a safe and reliable cutting or severing action on the medical tube substantially reducing the potential for accidents. It also enhances the ability of the healthcare professional to reliably cut the tube so as to not have to cut the tube again because of an inaccurate first cut.

In the following description, as is traditional, the term “proximal” refers to the portion of the apparatus closest to the operator while the term “distal” refers to the portion of the apparatus remote from the operator. Although the specific focus of this disclosure will be on a preferred method of cutting catheters, it will be noted that catheters are merely representative of a type of medical tube. Other tubes may include flexible cannulas, shunts, guidewires and any other conduit utilized during a medical or surgical procedure.

Referring now to the drawings where like reference numerals identify identical or substantially similar elements throughout the views, various embodiments of the present apparatus for cutting medical tubes will now be described.

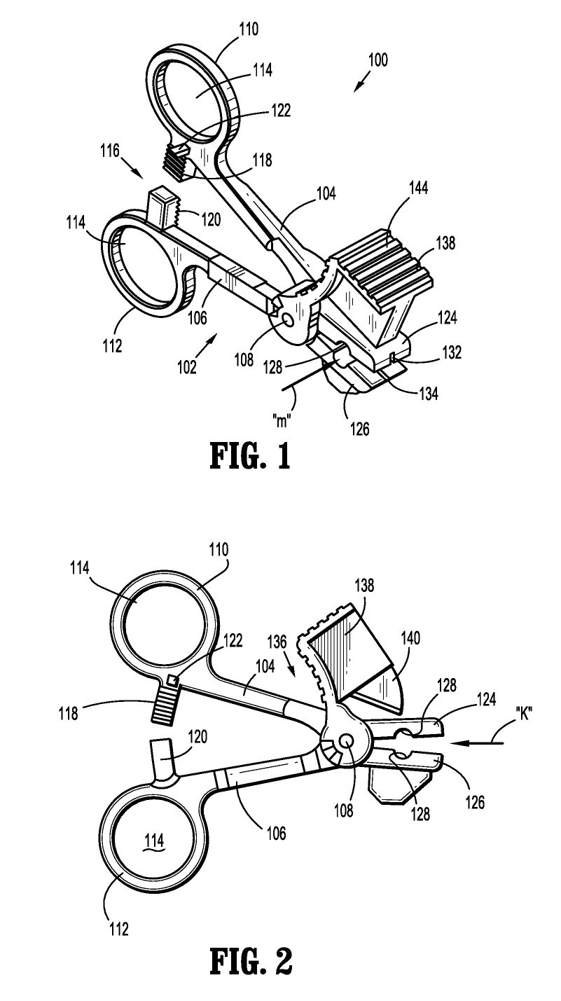

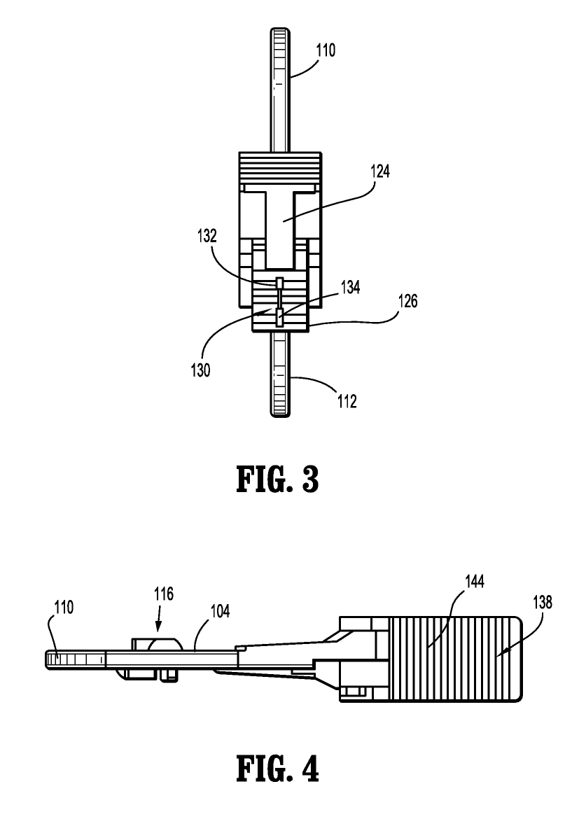

With reference to FIGS. 1-6, a first embodiment of a medical apparatus for cutting medical tubes in accordance with the present disclosure is generally designated as medical apparatus 100. Medical apparatus 100 facilitates the cutting of medical tubes of various diameters and lengths. As seen in FIG. 1, medical apparatus 100 includes frame 102 having first and second elongate members 104, 106 operatively connected to each other via fastening section 108. Fastening section 108 may be, as shown in FIG. 1, a pivot pin that interconnects first and second elongate members 104, 106, and permits relative pivotal movement. Other variations of fastening section 108 are also envisioned. For example, elongate members 104, 106 may be manufactured such that two components form a snap fit. Alternatively, elongate members 104, 106 may be connected via a cam pin and slot mechanism.

Each elongate member 104, 106 includes corresponding handle portions 110, 112. Handle portions 110, 112 are adapted for grasping engagement by the healthcare professional. Each handle portion 110, 112 may include an opening or finger loop 114 configured for receiving at least one finger. Although the drawings show openings 114 having a circular shape, other shapes are envisioned. In addition, the present disclosure envisions a medical apparatus 100 without finger loops or openings 114.

Medical apparatus 100 may include a locking mechanism, generally identified as reference number 116, configured to lock first and second elongate members 104, 106 at predetermined relative positions. Locking mechanism 116 may be any conventional means to engage first and second elongate members in locked position. Locking mechanism 116 may be a ratchet type locking mechanism. Locking mechanism 116 includes ratchet teeth 118, 120 on respective handles 110, 112. Ratchet teeth 118, 120 interlock to releasably secure handles 110, 112 at selective predetermined positions relative to each other. Locking mechanism 116 may include release element 122 adapted to disengage ratchet teeth 118, 120. Release element 122 may be a protrusion or raised portion depending laterally from handle 110. Release element 122 may be engaged to laterally displace handle 110 from handle 112 thereby causing release of ratchet teeth 118, 120. Locking mechanism 112 alternatively may be devoid of release element 122 whereby handles 110, 112 may be laterally displaced through direct engagement with at least one of the handles 110, 112.

Elongate members 104, 106 include respective tube support jaws 124, 126 disposed remote from handles 110, 112. Tube support jaws 124, 126 each include respective tube support mounts 128 or holding structures for supporting the medical tube. Tube support mounts 128 define recesses or indentations having semi-circular cross-sectional areas. Other configurations and cross-sections, such as oval, conical or tapered are also envisioned. Tube support mounts 128 are adapted and dimensioned for supporting a medical tube, such as a catheter. In one embodiment, the cross-sectional area of the combined tube support mounts 128 is dimensioned to retain a catheter tube having diameters ranging from 3-34 French on the French Catheter Scale. In one embodiment, tube support mounts 128 may be specifically dimensioned to support a catheter having an outside diameter of 11.5 Fr. In another embodiment, tube support mounts 128 are may be specifically dimensioned to support a catheter having an outside diameter of 13.5 Fr.

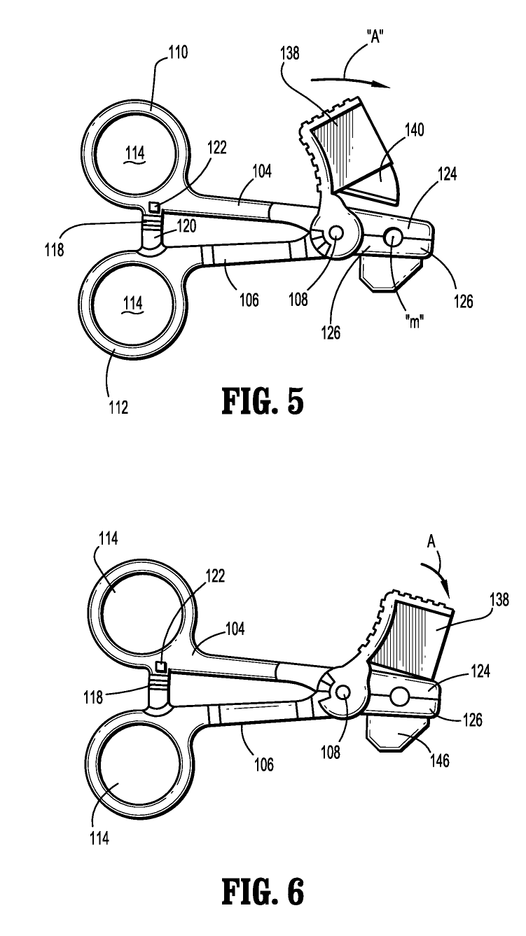

First and second elongate members 102, 104 are adapted for relative pivotal movement about pivot pin 106 between a first or open position depicted in FIG. 2 and a second or approximated position depicted in FIG. 5. When first and second elongate members 102, 104 are in the first position, tube support jaws 124, 126 are spaced relative to each other, thereby facilitating positioning of a medical tube in a location proximal to the tube support mounts 128. In particular, tube support jaws 124, 126, when in the open position, permit lateral loading of the medical tube by advancing the desired tube portion between the tube support jaws 124, 126 in the direction of directional arrow “k” of FIG. 2. In this manner, axial loading of the medical tube along the axis of an opening within the cutting head, shown in the directional arrow “m” of FIG. 1, is also possible. When first and second elongate members 104, 106 are in the second position of FIG. 5, tube support jaws 124, 126 are approximated and are therefore capable of capturing the medical tube within tube support mounts 128. First and second elongate members 104, 106 may be normally biased to the first open position via a spring or resilient member disposed between the two members 104, 106.

Tube support jaws 124, 126 may include visualization indicator 130 to permit a healthcare professional to observe the cutting point or mark on the medical tube to assist in severing the medical tube at the proper location. It is envisioned that medical tubes may have predefined external markings corresponding to respective tube lengths. Alternatively, the clinician may mark the medical tube at a desired length at the operative site. In one embodiment, the visualization indicator 130 is in the form of corresponding and aligned slits 132, 134 defined within the distal surfaces of respective tube support jaws 124, 126. The cross-sectional area of visualization indicator 130 is large enough to permit visual inspection of the cutting point or marking on the medical tube. Visual indicator 130, in the form of slits 132, 134, is substantially aligned with the cutting plane of the cutting element. Thus, the visual presence of the tube marking within visual indicator will ensure that the cut made will be at the desired marked location.

With reference now to FIGS. 1 and 5-6, frame 102 further includes manually actuated cutter mechanism 136. Manually actuated cutter mechanism 136 includes manual engageable member 138 and cutting element or blade 140 which is affixed to the manual member 138 by conventional means. Manual member 138 is mounted to first and second elongate members 104, 106 via pin or rod 142 and is adapted for pivotal movement about the pin 142. Manual member 138 includes surface 144, a surface to which a healthcare professional applies force or pressure. Surface 144 has indentations or a knurled arrangement to facilitate gripping engagement thereof by the healthcare professional. Manual member 138 and cutting blade 140 move independently of the relative movement of first and second members 102, 104 to sever a medical tube captured within tube support mounts 128 when first and second elongate members 124, 126 are in the second approximated position. In particular, manual member 138 and cutting blade 140 are mounted for pivotal movement through an arc of motion and relative to the tube support jaws 124, 126 between initial position depicted in FIG. 5 and an actuated position depicted in FIG. 6. As manual member 138 and cutting blade 140 move to the actuated position of FIG. 6, the cutting blade 140 contacts and then cuts the medical tube located in the tube support mounts 128. In addition, in the actuated position, cutting blade 140 is received within receiving member 146 whereby, the cutting edge of cutting blade is covered. Receiver element 146 depends from the lower surface of tube support jaw 126 and may define a groove or slot for receiving the cutting edge of the cutting blade 140. As depicted in FIG. 1, tube support jaw 126 may have groove 148 to at least partially receive cutting blade 140.

During use, a clinician positions the tube in tube support mounts 128 while the first and second elongate members 102, 104 are in the first or open position. As indicated hereinabove, the tube may be advanced in a lateral direction, e.g., through the distal opening defined between the spaced tube support jaws 124, 126 as indicated by directional arrow “k” (FIG. 2). Alternatively, the medical tube may be inserted in an axial direction with respect to the axes of the recesses of tube support mounts 128 as indicated by the directional arrow “m” (FIG. 1) while head portions are in a partially approximated or fully approximated condition. Regardless of the approach, the clinician moves handles 110, 112 toward each other to approximate tube support jaws 124, 126. Tube support mounts 128 secure the medical tube with substantially minimal or negligible deformation of the tube. The marking on the medical tube may be visualized through visual indicator 130. If the marking is not visible, the medical tube may be manipulated or slid within tube support mounts 128 to properly align the marking. The clinician may then actuate manual member 138 and cutting blade 140 to cut or sever the tube. This is affected by pivoting manual member 138 in the direction of arrow “A” through an arc of motion whereby cutting blade 140 severs the tube. In the alternative, cutting blade 140 may be dimensioned to move in a linear manner similar to the motion of a guillotine. The clinician may return manual member 138 to its initial position depicted in FIG. 2. Alternatively, manual member 138 may return to the initial position under the influence of a biasing device such as a coil spring. In addition, another biasing device may return elongate members 102, 104 to their first position when the clinician releases at least one of the handles 110, 112.

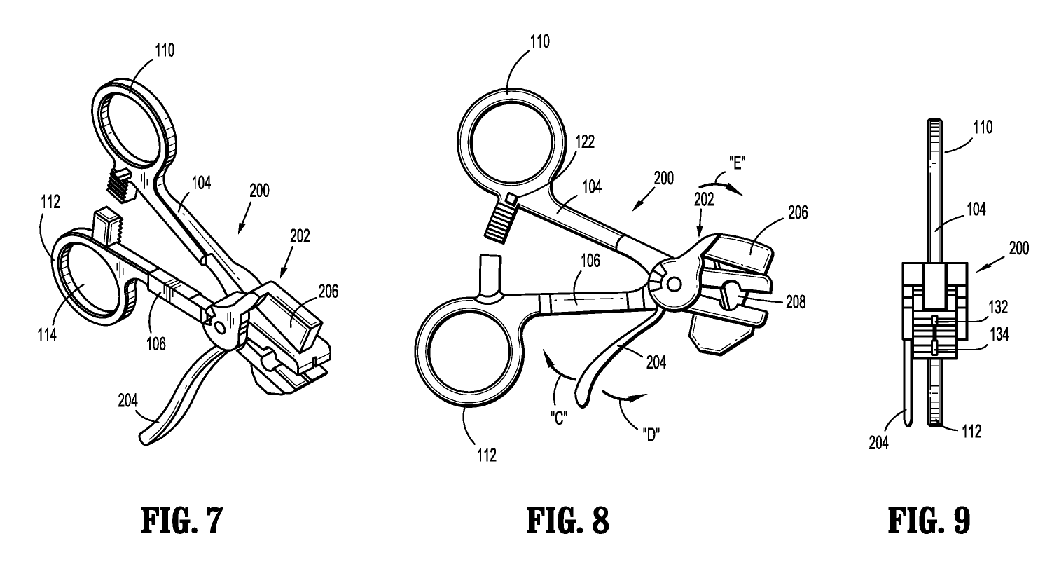

FIGS. 7-9 illustrate a medical apparatus 200 substantially similar to the medical apparatus 100 shown in FIGS. 1-6. However, in accordance with this embodiment, manually actuated cutter mechanism 202 includes trigger 204 which depends downwardly relative to handle 106. Trigger 204 is connected to blade mount 206 to which cutting blade 208 is mounted. Any means for mounting cutting element 208 to blade mount 206 are envisioned. In one embodiment, trigger 204 is a proximal extension monolithically formed with blade mount 206. During operation, trigger 204 is displaced in the direction of directional arrow “C” to cause blade mount 206 and cutting blade 208 to rotate about pivot pin 108 in the direction indicated by arrow “E” to sever the tube. Thereafter, the clinician may move blade mount 206 and cutting blade 206 to its initial position by moving trigger 204 in the direction indicated by arrow “D.” In other respects, medical apparatus 200 functions in a similar manner to medical apparatus 100 of FIGS. 1-6.

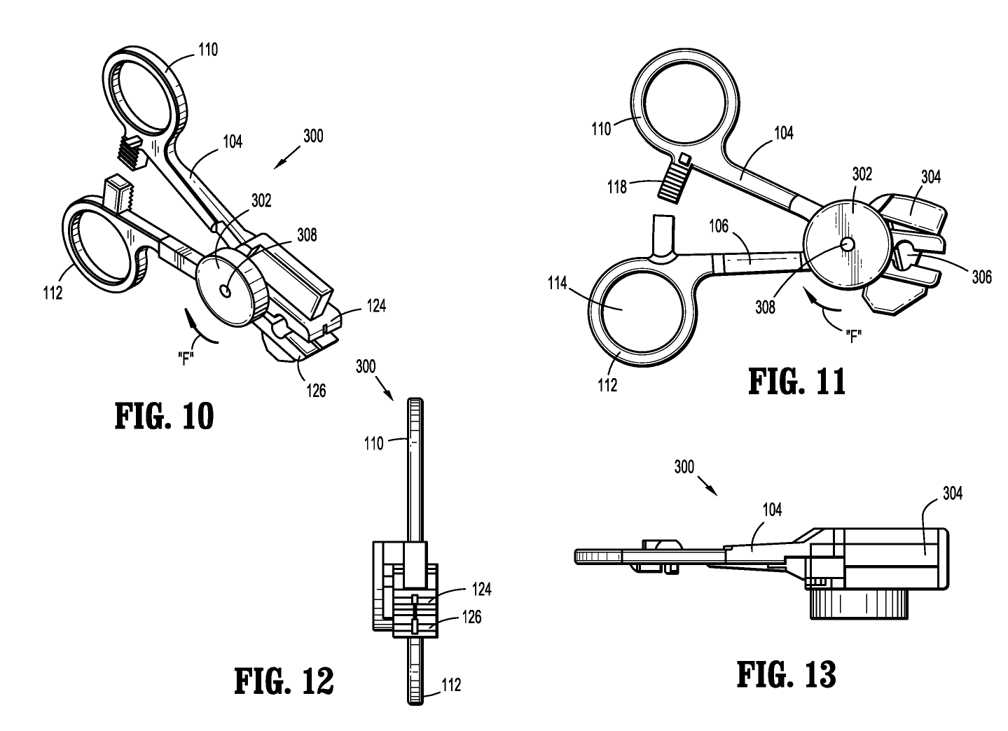

FIGS. 10-13 illustrate another embodiment of the medical apparatus of the present disclosure. Medical apparatus 300 is substantially similar to medical apparatus 200 of FIGS. 7-9; however, in accordance with this embodiment manually actuated cutter mechanism includes control knob 302, blade mount 304 connected to the control knob 302 and cutting blade 306 mounted to the blade mount 304. Control knob 302 is adapted to rotate about fastening pin or rod 308 in the direction of directional arrow “f” to move blade mount 304 and cutting blade 306 through an arc of rotation to sever the medical tube. Blade mount 304 and cutting blade 306 move independent of the relative motion of elongate members 104, 106 to cut the medical tube positioned in tube support mounts 128. Control knob 302 may have various shapes including the circular shape, an elliptical shape or a polygonal shape.

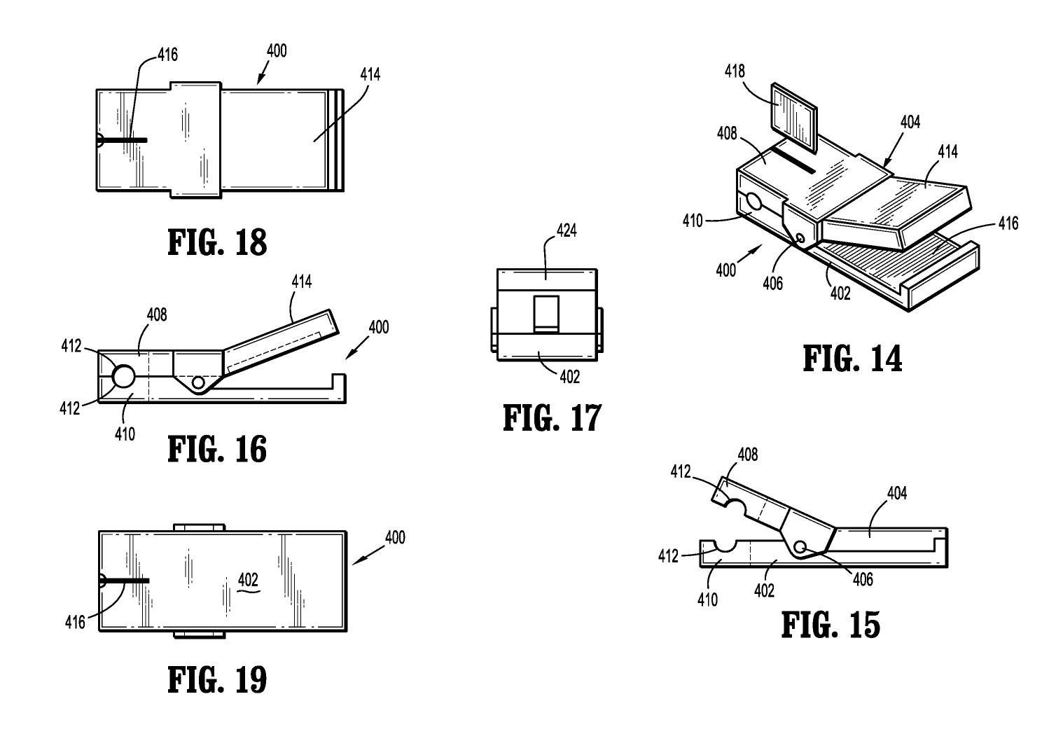

Referring now to FIGS. 14-18, another embodiment of the presently disclosed medical apparatus is generally designated as 400. Medical apparatus 400 includes base element 402 and movable element 404 mounted to the base element 402 via pivot pin 406 extending through cooperating pair of apertures of the base element 402 and the movable element 404. Movable element 404 and base element 402 each have respective grasping jaws 408, 410. Each of the grasping jaws 408, 410 includes corresponding tube support mounts 412 which capture the medical tube in a substantially similar manner to the prior embodiment. Movable element 404 rotates about pivoting pin 406 and relative to base element 402 between the open position of grasping jaws 408, 410 depicted in FIG. 15 and the closed position of the grasping jaws 408, 410 depicted in FIG. 16.

In one embodiment, movable element 404 has a manual member 414 depending at an oblique relation relative to grasping jaws 408. This arrangement presents manual member 414 to be engaged by the healthcare professional to move the movable element 414 between the open and closed positions. Base element 402 may include recess 416 dimensioned to receive manual member 414 when in the open position depicted in FIG. 15.

Base element 402 and movable section 404 each include channel 416 extending completely through the respective element. Channels 416 of respective base 402 and moveable section 404 are substantially aligned when base element 402 and movable element 404 are in the closed position of FIGS. 16 and 18, and are arranged to intersect tube support mounts 412 of grasping jaws 408, 410. Channels 416 are adapted to receive a cutting element 418, such as a blade, and permit passage of the cutting element to cut a medical tube secured in tube support mounts 412. Cutting element 418 is separate from apparatus 400 and is manually introduced within channels 416 by the healthcare professional. Cutting element 418 passes through channels 416 to sever the tube via manipulation by the clinician. To facilitate insertion of the cutting element, channels 416 may be wider adjacent the open ends.

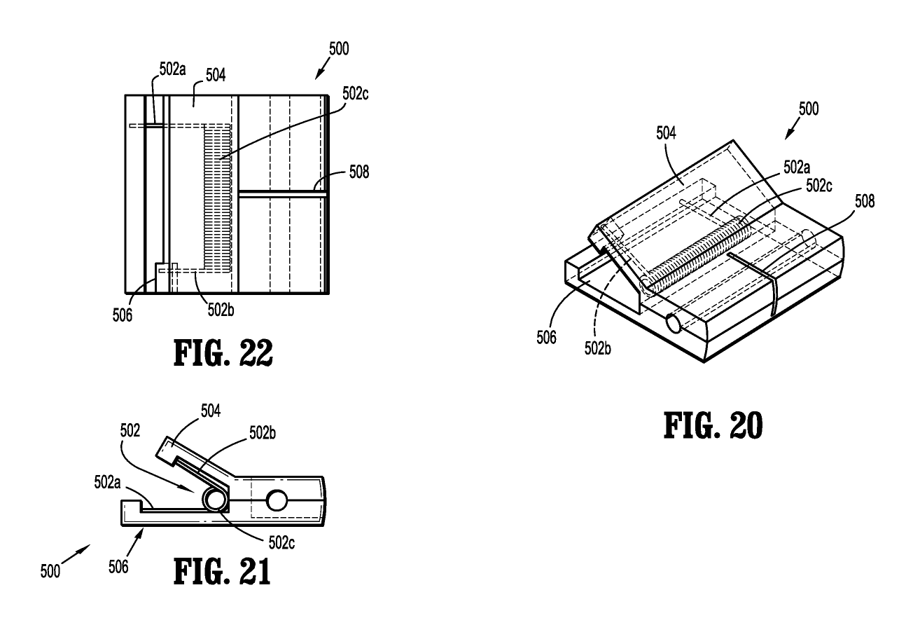

FIGS. 20-22 illustrate another embodiment of the presently disclosed medical apparatus. This embodiment is generally designated as medical apparatus 500. Medical apparatus 500 is substantially similar to medical apparatus 400, but, includes a biasing device 502 disposed in mechanical cooperation with manual member 504 and base element 506. Biasing device 502 is configured to bias manual member 504 to the first position, as illustrated in FIGS. 20 and 21. In the illustrated embodiment, biasing device 502 is a coil spring having first and second legs 502a, 502b and a coil segment portion 502c. First leg 502a engages base element 506 and second leg 502b engages manual member 504 to bias manual member 504 and base element 506 away from each other to the first position as depicted in FIGS. 20 and 21. The present disclosure contemplates that biasing device 502 may be any other kind of biasing device 502 suitable for biasing manual member 504 towards the first position including e.g., a leaf spring or a resilient element. A cutting element such as blade 418 shown in the embodiment of FIGS. 14-19 may be advanced through channel 508 to sever the tube. In other respects, medical apparatus 500 operates in a similar manner to the medical apparatus of FIGS. 14-19.

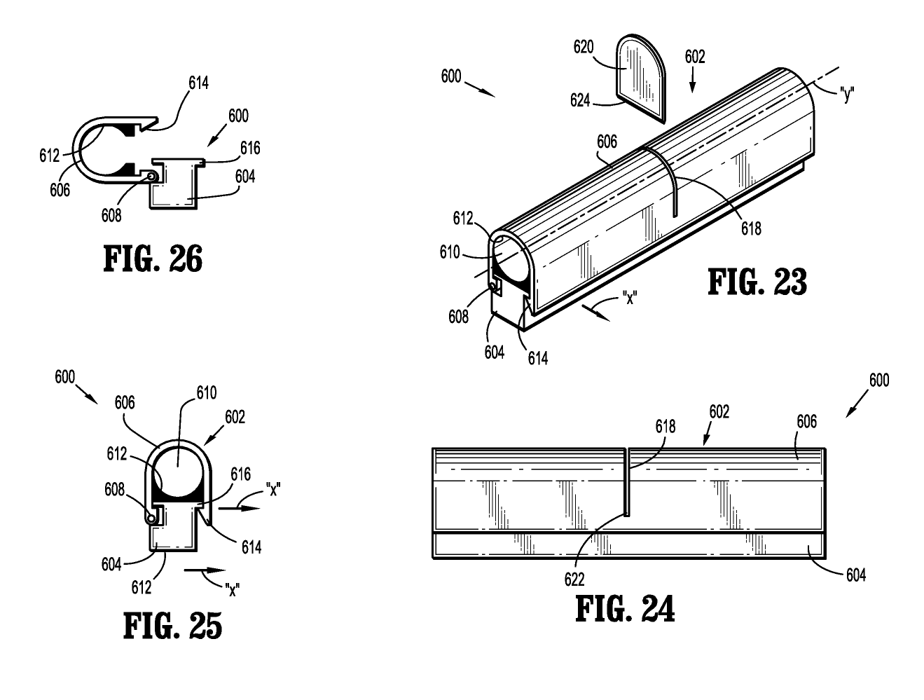

FIGS. 23-26 illustrate another embodiment of the presently disclosed medical apparatus. Medical apparatus 600 includes an elongate body 602 fabricated from a suitable flexible or rigid material. Elongate body 602 includes base 604, and cover 606, mounted to the base via pivot pin 608. Cover 604 pivots about pivot pin 608 between the closed position depicted in FIG. 25 and the open position depicted in FIG. 26. Other means for connecting cover 606 to base 604 are envisioned including a living hinge, cam slot arrangement or other means appreciated by one skilled in the art.

In the closed position of FIGS. 23 and 25, cover 606 defines central lumen 610 within respective internal recess 612 of base 604 and the cover 606. Internal recess 612 may be an annular or circular shape to define central lumen 610. Central lumen 610 accommodates the medical tube. Cover 606 may define locking projecting 614. Locking projection 614 engages corresponding locking shelf 616 of base 604 to releasably secure cover 606 to the base 604 when in the closed position. Locking projection 614 may be released from locking shelf 616 by displacing the locking element in a radial outward direction in the direction of the directional arrow “x”. As indicated hereinabove, cover 606 may be resilient whereby locking projection 614 may be temporally deformed in the outward direction to release from locking shelf 616.

Cover 606 further defines blade receiving slot 618 adjacent the midpoint of the cover 606. Blade receiving slot 618 is substantially orthogonal to the axis “y” of elongated body 602 and intersects central lumen 610. Blade receiving slot 618 receives a separate cutting blade 620 utilized to sever the medical tube. Base 604 may incorporate a recess or slot 622 in alignment with blade receiving slot 618 to ensure that the cutting edge 624 of cutting blade 620 passes completely through the medical tube.

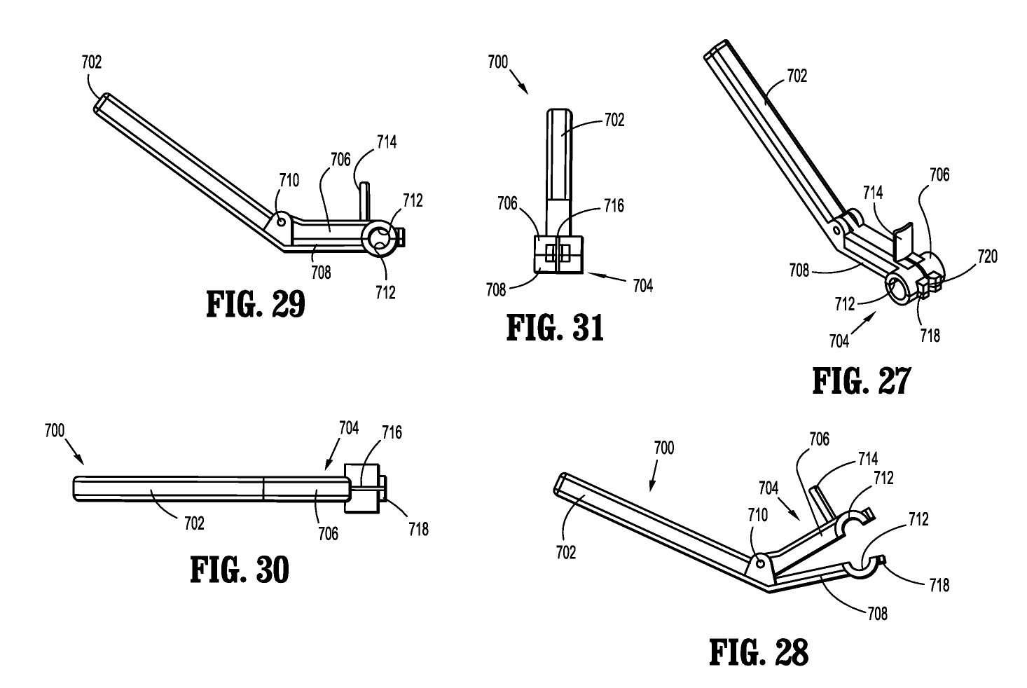

FIGS. 27- 31 illustrate a further embodiment of the presently disclosed medical apparatus. This embodiment is generally designated as medical apparatus 700. Medical apparatus 700 includes handle 702 and head assembly 704 operatively connected to the handle 702. Head assembly 704 includes first and second jaws 706, 708. Jaw 706 is pivotally mounted relative to jaw 708 via pivot pin 710. Jaw 706 pivots about pivot pin 710 between a first or open position depicted in FIG. 28 and a second or closed position depicted in FIG. 29.

Each jaw 706, 708 includes respective tube support mount 712. Tube support mounts 712 are configured to receive a medical tube such as a catheter. When jaw 706 is in the first position, the healthcare professional may place a medical tube in tube support mount 712. While in the second position, jaw 706 in conjunction with jaw 708 capture the medical tube disposed between tube support mounts 712. Overall, tube support mounts 712 are adapted to retain a medical tube. In the depicted embodiment, the combined cross-section of the tube support mounts 712 has a circular shape.

Jaw 706 includes a manual member 714. In operation, the manual manipulation of manual member 714 by the clinician moves jaw 706 between the first position and the second position. Manual member 714 protrudes orthogonally with respect jaw 706.

Head assembly 704, as a whole, has channel 716 configured to receive a cutting element (not shown). Channel 716 traverses tube support mounts 712. Channel 716 receives a cutting element to cut a medical tube at a predetermined length. To facilitate insertion of the cutting element through channel 716, head assembly 704 includes at least one two guides 718 projecting from each of jaws 706,708. Guides 718 have tapered inner surfaces 720 leading to channel 716. Tapered surfaces 720 guide the cutting element into channel 716.

It will be understood that various modifications and changes in form and detail may be made to the embodiments described hereinabove without departing from the spirit and scope of the present disclosure. Therefore, the above description should not be construed as limiting but merely as exemplifications of the embodiments. Those skilled in the art will envision other modifications within the scope and spirit of the present disclosure as defined by the claims appended hereto.

What is claimed is:

1. An apparatus for cutting medical tubes, which comprises:
a frame including first and second members, each of the first and second members having a tube support mount to assist in supporting a medical tube, the first and second members adapted for relative movement between a first position for facilitating positioning of the medical tube proximal the tube supporting mounts and a second position for capturing the medical tube within the tube supporting mounts; and
a cutting element mounted to the frame, the cutting element moveable through a cutting plane and independent of the relative movement of the first and second members to sever the medical tube captured within the tube support mounts when in the second position of the first and second members.

2. The apparatus according to claim 1 including a manual member operatively connected to the cutting element, the manual member actuable through manual manipulation of a clinician to move the blade.

3. The apparatus according to claim 1 wherein the first and second member include respective tube support jaws, the tube support jaws defining the tube support mounts.

4. The apparatus according to claim 3 wherein the tube support jaws are adapted for relative pivotal movement between the open position and the approximated position.

5. The apparatus according to claim 3 including a visual indicator for aligning the medical tube relative to the tube support mount and in defined relation with the cutting plane of the cutting element.

6. The apparatus according to claim 5 wherein the tube support jaws define a slit extending at least partially therethrough and in alignment with the cutting plane of the cutting element, the slit permitting visualization of the medical tube within the tube support mounts.

7. The apparatus according to claim 1 including a manual member operatively connected to the cutting element, the manual member moveable to cause movement of the cutting element through the cutting plane to sever the medical tube.

8. The apparatus according to claim 7 wherein the manual member is a lever pivotally coupled to the frame.

9. The medical apparatus according to claim 7 wherein the manual member is a knob disposed in mechanical cooperation with the blade.

10. A medical apparatus for cutting medical tubes, which comprises:
a handle;
a head operatively associated with the handle, the handle including holding structure configured for supporting a medical tube and adapted for movement upon actuation of the handle between an open position to receive the medical tube and an approximated position to capture the medical tube;
a blade mounted for movement relative to the holding structure to cut the medical tube captured by the holding structure; and
a manual member operatively connected to the blade and actuable through manual manipulation by a clinician to move the blade.
